(19) United States
(12) Patent Application Publication
(10) Pub. No.: US 2002/0154119 A1
(43) Pub. Date: Oct. 24, 2002

(54) Apparatus and method for performing branch processing according to a user indicated selection from displayed graphics

(76) Inventors: Yervant D. Lepejian, Palo Alto, CA (US); Gurgen Lachinian, Palo Alto, CA (US); Rafik Marutyan, Yerevan (AM)

Correspondence Address: VICTOR H. OKUMOTO, HPL TECHNOLOGIES, 2033 GATEWAY PLACE, SAN JOSE, CA, 95110, US

(21) Appl. No.: 09/841,653

(22) Filed: Apr. 24, 2001

(51) Int. Cl. G06T 11/20

(52) U.S. Cl. 345/440

(57) ABSTRACT

An apparatus and method are described for performing branch processing according to a user indicated selection from displayed graphics. A chart engine in a workflow receives a data file having a header followed by data. The header includes parameters and branch processing information. The chart engine generates graphics data from the received data according to the parameters information, and an output engine stores the graphics data in a data file along with the original header information. The graphics data is readable by a viewer that displays graphics generated from the graphics data on a computer display. When the user indicates a selection from the displayed graphics, the viewer detects the user indicated selection, reads the branch processing information from the header of the data file, and performs branch processing according to the user indicated selection.

### FIELD OF THE INVENTION

The present invention generally relates to interactive computer environments and in particular, to an apparatus and method for performing branch processing according to a user indicated selection from displayed graphics.

### BACKGROUND OF THE INVENTION

In an interactive computer environment, a user may desire to obtain additional information about graphics data being displayed on a computer screen. A convenient way of doing so would be for the user to click on the displayed graphics with a pointing device such as a computer mouse at a point or area where such additional information is desired. The additional information may then be generated and displayed on the computer screen according to preprogrammed instructions that process certain data corresponding to the user indicated selection in a desired fashion.

The type of processing to be performed may depend upon various application and user specific factors. Therefore, it is useful to provide the user with multiple process options through branch processing techniques after the user's initial selection from the displayed graphics is detected. Also, it is useful to provide programmers of the branch processing with a flexible structure for programming and reprogramming of the branch processing. Further, it is useful to provide a branch processing approach that is not dependent upon when or where the user interacts with the displayed graphics.

### OBJECTS AND SUMMARY OF THE INVENTION

Accordingly, it is an object of the present invention to provide an apparatus and method for performing branch processing according to a user indicated selection from displayed graphics.

Another object is to provide an apparatus and method for performing branch processing according to a user indicated selection from displayed graphics that allows flexible programming of process options to be provided to the user.

Another object is to provide an apparatus and method for performing branch processing according to a user indicated selection from displayed graphics that is not restricted by when or where the graphics data is displayed.

These and additional objects are accomplished by the various aspects of the present invention, wherein briefly stated, one aspect of the invention is an apparatus for performing branch processing according to a user indicated selection from displayed graphics, comprising a processor programmed to display graphics generated from data included in a data file, detect a user indicated selection from the displayed graphics, read information of branch processing included in the data file, and perform the branch processing according to the user indicated selection.

In another aspect, an apparatus for performing branch processing according to a user indicated selection from displayed graphics, comprises: means for displaying graphics generated from data included in a data file; means for detecting a user indicated selection from the displayed graphics; means for reading information of branch processing included in the data file; and means for performing the branch processing according to the user indicated selection.

In still another aspect, a computer readable medium stores a data file comprising: a data portion having graphics data displayable on a computer display screen; and a header portion having information of branch processing including identification of a process option to be executed after detection of a user indicated selection from displayed graphics generated from the graphics data.

In yet another aspect, a computer implemented method for performing branch processing according to a user indicated selection from displayed graphics, comprises: displaying graphics generated from data included in a data file; detecting a user indicated selection from the displayed graphics; reading information of branch processing included in the data file; and performing the branch processing according to the user indicated selection.

Additional objects, features and advantages of the various aspects of the invention will become apparent from the following description of its preferred embodiments, which description should be taken in conjunction with the accompanying drawings.

### BRIEF DESCRIPTION OF THE DRAWINGS

FIG. 1 illustrates a block diagram of a computer system for performing branch processing according to a user indicated selection from displayed graphics, utilizing aspects of the present invention.

FIG. 2 illustrates a prior art workflow displayed on a computer display screen.

FIG. 3 illustrates a workflow displayed on a computer display screen, utilizing aspects of the present invention.

FIGS. 4 and 5 respectively illustrate a prior art data file structure and corresponding header.

FIGS. 6 and 7 respectively illustrate a data file structure and corresponding header, utilizing aspects of the present invention.

FIG. 8 illustrates displayed graphics in the form of a bar chart with a user indicated selection of a point on the chart.

FIG. 9 illustrates displayed graphics in the form of a bar chart with a user indicated selection of an area of the chart.

FIG. 10 illustrates displayed graphics in the form of a set of images.

FIG. 11 illustrates a flow diagram of a method for performing branch processing according to a user indicated selection from displayed graphics, utilizing aspects of the present invention.

FIG. 12 illustrates a flow diagram of performing branch processing according to a user indicated selection from displayed graphics, utilizing aspects of the present invention.

### DETAILED DESCRIPTION OF THE PREFERRED EMBODIMENT

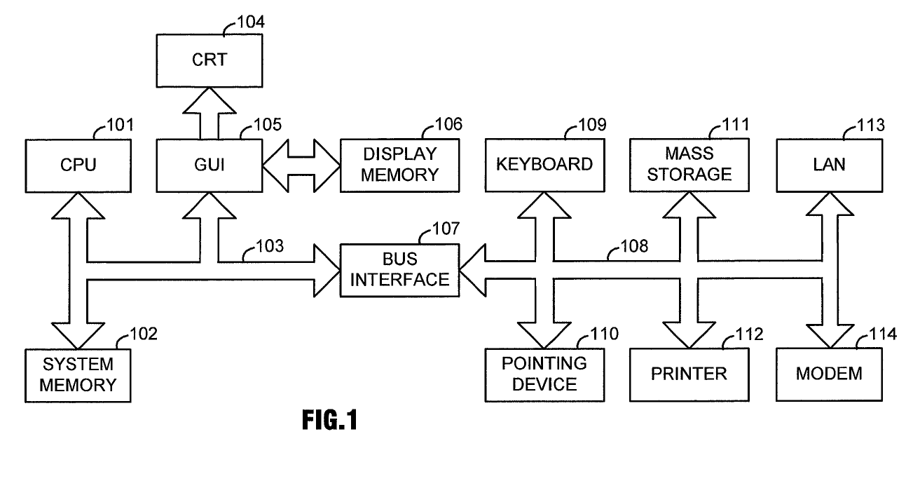

FIG. 1 illustrates a block diagram of a computer system for performing branch processing according to a user indicated selection from displayed graphics. Included in the computer system are a central processing unit (CPU) 101 such as those typically employed in engineering work stations, system memory 102 such as dynamic random-access memory (DRAM) or other random-access solid-state memory, mass storage 111 such as one or more hard disk drive units, and a number of input and output devices for user interaction with the computer system. The input devices include a keyboard 109 and a user manipulated pointing device 110 such as a mouse, touch pad, digital tablet, trackball or joystick. The output devices include a cathode-ray-tube (CRT) monitor 104 or other computer display such as an active matrix liquid crystal display, and a printer 112 or other output device such as a plotter.

The CPU 101 is coupled to the system memory 102, a bus interface 107, and the CRT 104 through system bus 103. A graphical user interface (GUI) 105 is employed in conjunction with display memory 106 for a user to interact with the computer system through the CRT 104, keyboard 109 and pointing device 110. The bus interface 107 couples the keyboard 109, the pointing device 110, the mass storage 111, and the printer 112 to the CPU 101 through a peripheral bus 108 and the system bus 103. A local area network (LAN) 113 and a modem 114 are also included. Both the LAN 113 and modem 114 are useful for communication purposes with other computer systems and/or databases, as well as other conventional purposes such as downloading programs and data from such other computer systems and/or databases into the mass storage unit 111.

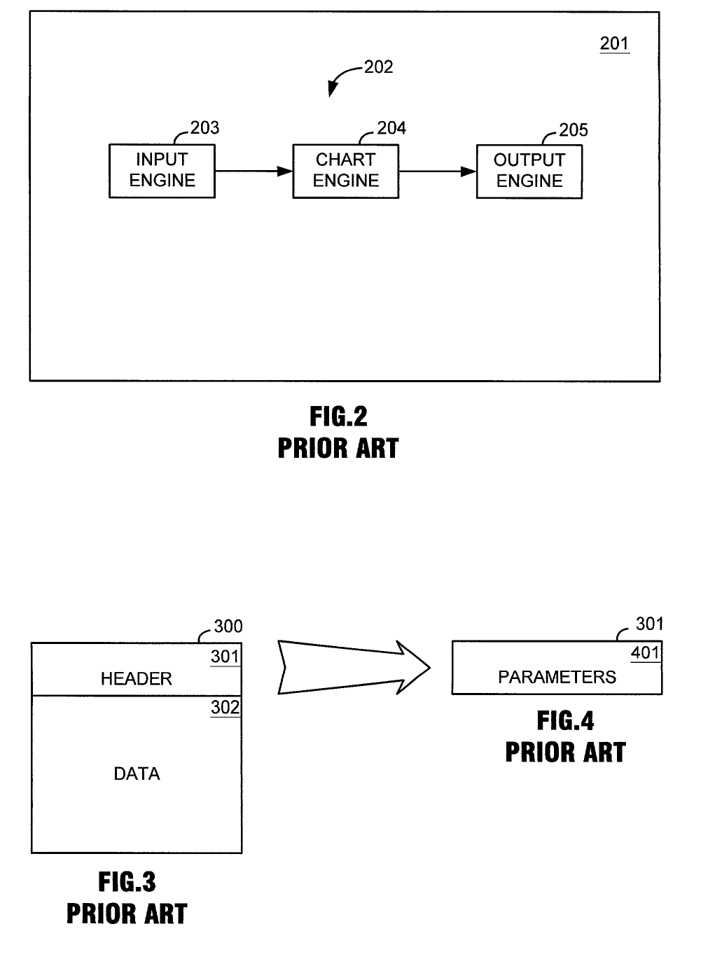

FIG. 2 illustrates an example of a workflow 202 as displayed on a computer display screen 201 by a workflow editor such as WorkflowView™, a product of HPL Inc. of San Jose, Calif. A “workflow” means one or more engines linked together to perform a specific task or series of tasks. It employs a data driven methodology based upon data flow modeling techniques from the object-oriented design world. As a declarative versus a procedural methodology, it requires very little from the developer in the way of programming knowledge, thinking or ability. An “engine” in the workflow means a software module that performs a function such as data retrieval, analysis, computation, data manipulation, logic, display, or data storage. A “data file” as used herein includes any means for transmitting, sharing or maintaining data and may include files, databases, shared memory structures, and data streams, as well as other known techniques and structures for performing such and similar functions. The workflow 202 is executed by workflow control software such as Workflow Wizard™, another product of HPL, Inc.

One particularly useful application of workflows is in the area of semiconductor yield analysis. As a simple example of such an application, the workflow 202 includes an input engine 203, a chart engine 204 and an output engine 205. The input engine 203 extracts data according to selected parameters from a database and provides the extracted data to the chart engine 204. The selected parameters in this example include device, wafer and lot identifications. The extracted data includes defect data for specified integrated circuit devices, wafers and lots.

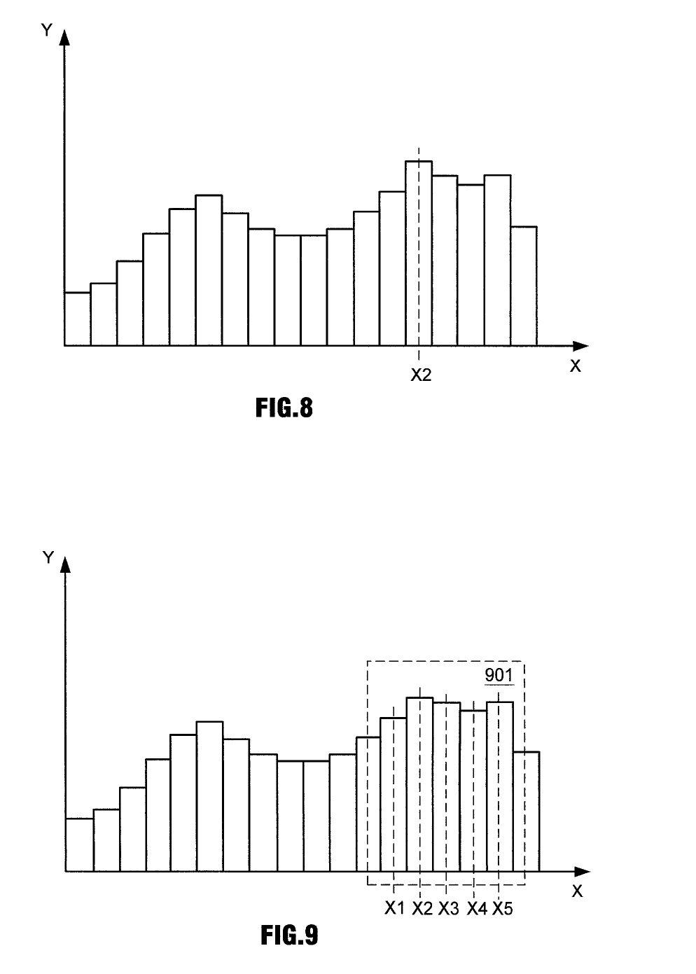

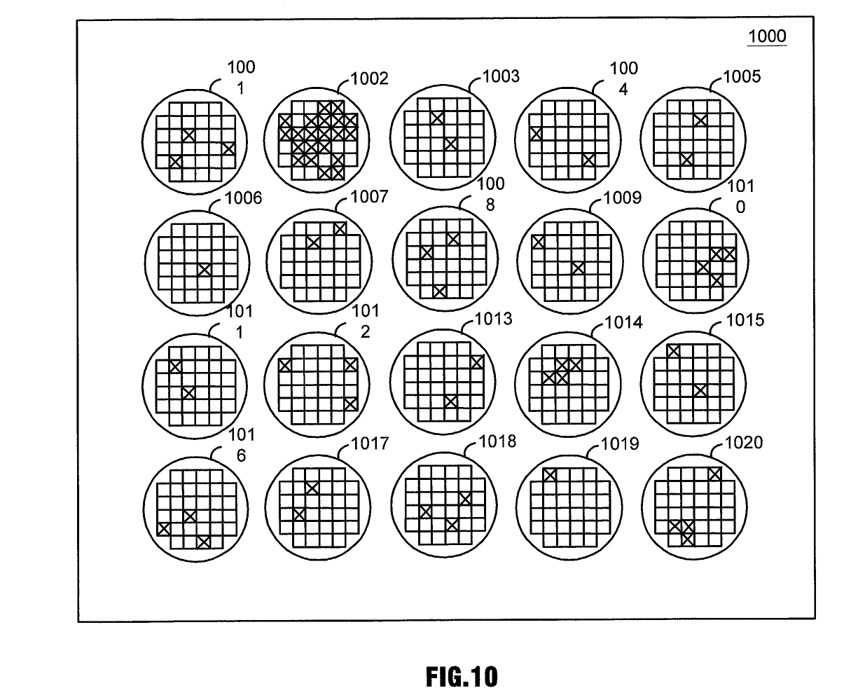

The chart engine 204 receives a data file including the extracted data from the input engine 203, and generates graphics data that is displayable on a computer display screen such as CRT 104. The graphics data may be in any one of a number of selectable formats such as bar charts, pie charts, polar plots, sets of images, and the like. FIGS. 8˜9 illustrate an example of a bar chart, and FIG. 10 illustrates an example of a set of wafer images. The output engine 205 receives a data file including the graphics data from the chart engine 204, and stores the graphics data in a data file for later viewing and/or invokes a specified viewer such as YieldXplorer™, another product of HPL, Inc, to immediately display the graphics data on a computer display screen.

FIG. 3 illustrates an example of a data file 300 having a header portion 301 and a data portion 302, as used in the workflow 202. The header portion 301 is further detailed in FIG. 4 as including parameter information 401 that an engine receiving the data file 300 reads to properly process data included in the data portion 302. As engines process and pass the processed data to other engines in a workflow through data files such as data file 300, the data passed in the data portion 302 may change. The parameter information 401 in the header portion 301, however, is generally passed unchanged from one processing engine to another.

To facilitate branch processing performed according to a user indicated selection from displayed graphics, the branch processing information may be programmed into a viewer that is displaying the graphics on a computer display. There are numerous problems with such an approach, however. For one, the viewer may not be constructed to readily facilitate such programming, thereby making such approach impracticable. Also, since the same viewer may be used to display the graphics generated from multiple workflows, branch processing for all such workflows must be identical, otherwise, unexpected results might occur. Therefore, to avoid this restriction, modified versions of the viewer would need to be maintained for each workflow incorporating different branch processing. Further, if graphics data included in the data file generated by output engine 205 is displayed on a different computer, the appropriate version of the viewer must be available on that computer, or again, unexpected results may occur.

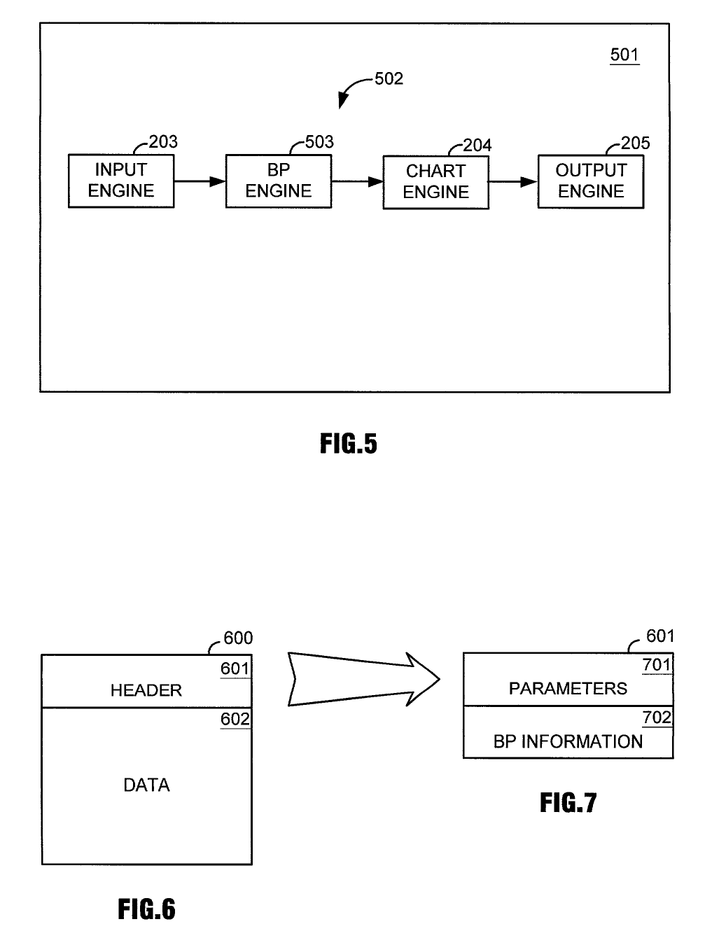

FIG. 5 illustrates a modified version 502 of the workflow 202 that facilitates branch processing according to a user indicated selection from displayed graphics. The input engine 203, chart engine 204 and output engine 205 in workflow 502 function as their identically referenced counterparts in workflow 202. A branch processing (“BP”) engine 503 has been included in the workflow 502, however, to write information of branch processing into the header 601 of a data file 600 provided to the chart engine 204. As shown in FIGS. 6 and 7, the structure of the data file 600 is the same as that of data file 300, with the exception that a branch processing information section 702 has been added to the header portion 601. Data stored in the data portion 602 and parameters information stored in the parameters section 701 of the data file 600 are the same as received by the BP engine 503 from the input engine 203. The branch processing information is then passed on in a subsequent data file from the chart engine 204 to the output engine 205. The output engine 205 then writes the branch processing information into a data file to be read by a viewer. A viewer adapted to read and process the branch processing information may then be used to display graphics generated from the data included in the data file, detect a user indicated selection from the displayed graphics, read information of branch processing included in the data file, and substantially perform the branch processing according to the user indicated selection.

As is readily apparent, effective use of the branch processing engine 503 allows a workflow programmer to easily program the branch processing that is to be performed according to a user indicated selection from displayed graphics. Since the branch processing information is provided by the output engine 205 along with the graphics data in a data file, the information is always available whenever graphics generated from the graphics data included in the data file is displayed on a computer display screen. Also, since only a specially adapted viewer, as previously described, is required to facilitate the branch processing in this case, the same viewer can be used for all workflows, thereby avoiding the problems associated with having to have a modified viewer specific to each workflow to accommodate such branch processing.

When the user views the displayed graphics on the computer display screen, the user may want to explore further by performing branch processing on a point or an area of the displayed graphics. For example, in FIGS. 8 and 9, a bar graph is depicted that includes defect data along the Y-axis and wafer identifications along the X-axis. To obtain more information on wafer X2, the user directs the pointing device to X2 on the computer screen and clicks an appropriate button on the pointing device. On the other hand, to obtain more information on wafers X1˜X5, the user manipulates the pointing device to define an area or window 901 around X1˜X5 on the computer screen and again, clicks an appropriate button on the pointing device.

The defect data as depicted in the bar graphs of FIGS. 8 and 9 may alternatively be presented as a set of images. For example, in FIG. 10, the set of images 1001˜1020 portray top views of the wafers that are identified along the X-axes of FIGS. 8 and 9. Squares in each wafer represent integrated circuit die, and X'd out squares indicate defective die on the wafer. By portraying the wafers in this fashion, the user can get a quick visual cue of not only the density of defects on each wafer, but also the clustering of defects on each wafer. In this example, to obtain more information on wafer 1002, the user may direct the pointing device to wafer 1002 on the computer screen and click an appropriate button on the pointing device.

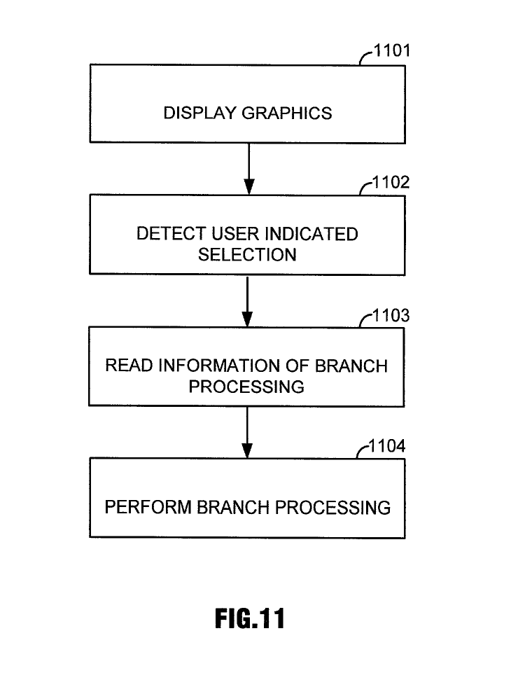

FIG. 11 illustrates a flow diagram of a method for performing branch processing according to a user indicated selection from displayed graphics. A processor such as CPU 101 preferably implements the method. In 1101, a viewer is launched to display graphics generated from data included in a data file such as data file 600. In a more complicated workflow than that depicted in FIG. 5, the viewer may be launched to display graphics generated from data provided by any one of several chart engines embedded in the workflow.

In 1102, the viewer detects a user indicated selection from the displayed graphics. The user indicates the selection by manipulating a pointing device such as the pointing device 110. By properly manipulating the pointing device and clicking a button or other indicator on or adjacent to the pointing device, the user can select a point or an area on the displayed graphics. Detection is then accomplished in a conventional fashion by receiving screen coordinate and control information from the pointing device.

In 1103, in response to detecting the user indicated selection, the viewer reads the branch processing information stored in the branch processing information section 702 of the header 600. The branch processing information includes information of process options that are either automatically executed or selectable by the user. The branch processing information is organized into one or more branches with each branch having one or more process options associated with it. The process options may be executable programs or workflows. Information for an executable program includes an executable name and execution parameters. Information for a workflow, on the other hand, includes an executable name, a workflow name, and execution parameters. In the case of a workflow, the executable name is the name of the program that runs the workflow, the workflow name identifies the workflow to be run by the program, and the execution parameters are parameters used in the execution of the workflow.

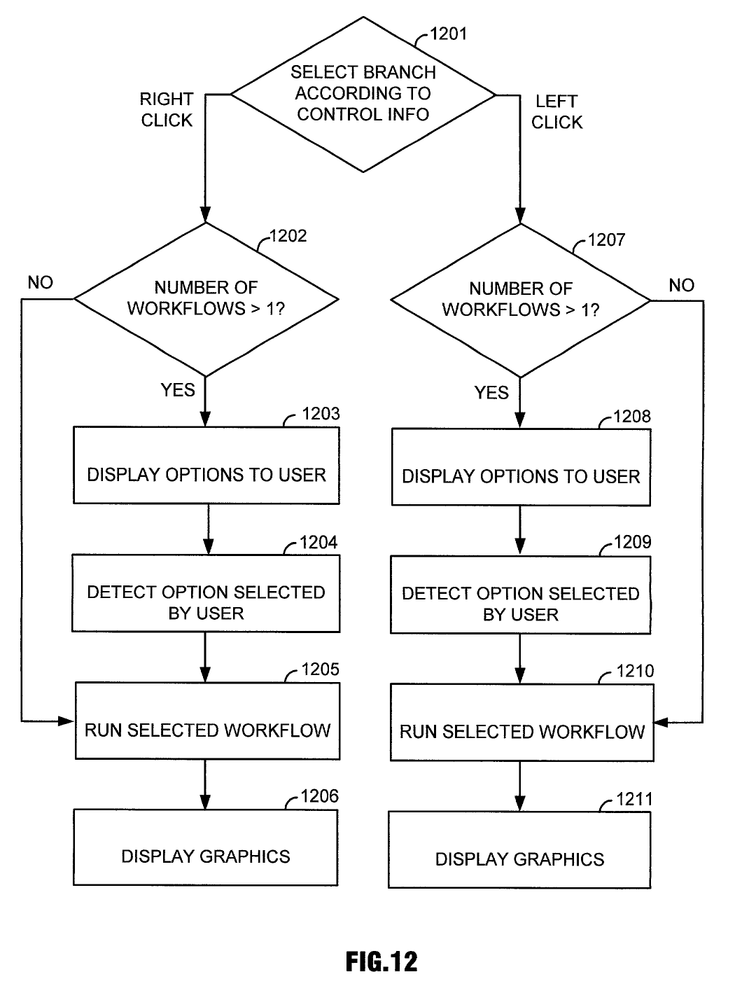

In 1104, the viewer performs branch processing according to the user indicated selection from the displayed graphics, as described by the example illustrated in the flow chart of FIG. 12. Now referring to FIG. 12, in 1201, the viewer first selects a branch included in the branch processing information read in 1103, according to control information included in the user indicated selection detected in 1102. In particular, if the control information resulted from the user depressing a right control on the pointing device (i.e., a right click), then a first branch is selected, and if the control information resulted from the user depressing a left control on the pointing device (i.e., a left click), then a second branch is selected. When the pointing device is a computer mouse, the first control may be a right button on the mouse and the second control may be a left button on the mouse. Additional controls on the pointing device or control keys on the keyboard may be used to select additional branches.

If the first branch is selected, for example, by the user clicking the right control on the pointing device, then in 1202˜1206, the viewer substantially performs and manages branch processing according to coordinate information included in the user indicated selection from the displayed graphics. In 1202, the viewer first determines whether the number of process options included in the selected branch is greater than one. This determination is straightforward from the branch processing information read from the header in 1103.

If the answer to 1202 is NO, then the number of process options included in the selected process branch must be equal to one. Jumping to 1205, the viewer causes the program identified in that process option to execute according to coordinate information included in the user indicated selection. Before the process option is executed, however, the coordinate information is mapped into appropriate data points of the displayed graphics so that the program executing the process option does so using the appropriate data points as selected by the user. In 1206, the viewer then displays the graphics generated from data in a data file provided by the executed process option. If a second level of branch processing had been defined in the branch processing information stored in the data file provided by the executed process option, then 1206 would effectively be 1101, and the viewer would repeat 1101˜1104 for that second level. Third and higher levels of branch processing may also be defined and performed in this fashion.

On the other hand, if the answer to 1202 is YES, then the number of process options included in the selected branch is greater than one. In this case, the user may select the process option that is to be executed from the available process options. Accordingly, in 1203, the viewer displays the available process options to the user as options on a menu on the computer display screen. After the user selects one of the available process options for execution, then in 1204, the viewer detects the user's selection. In 1205, the viewer causes the user selected process option to be executed and in 1206, the viewer displays graphics generated from data included in a data file provided by the executed process option on the computer display screen, as previously described.

If a second branch is selected, for example, by the user clicking the left control on the pointing device, then in 1207˜1211, the viewer performs a process option in the second branch according to coordinate information included in the user selected selection. Although the number and type of process options may be different than in the first branch, the procedure in 1207˜1211 is identical to that of 1202˜1206, and therefore, need not be repeated. Although not shown, third, fourth and more branches may also be provided with different numbers and types of process options, but with corresponding procedures identical to that of 1202˜1206.

Although the various aspects of the present invention have been described with respect to a preferred embodiment, it will be understood that the invention is entitled to full protection within the full scope of the appended claims.

We claim:

1. An apparatus for performing branch processing according to a user indicated selection from displayed graphics, comprising a processor programmed to display graphics generated from data included in a data file, detect a user indicated selection from said displayed graphics, read information of branch processing included in said data file, and perform said branch processing according to said user indicated selection.

2. The apparatus according to claim 1, further comprising a user manipulated pointing device providing said user indicated selection to said processor.

3. The apparatus according to claim 2, wherein said user manipulated pointing device is a computer mouse providing user selected display coordinate and user selected control information to said processor.

4. The apparatus according to claim 1, wherein said data is stored in a data portion of said data file, and said information of branch processing is stored in a header portion of said data file.

5. The apparatus according to claim 1, wherein said information of branch processing includes information for an executable program executed upon detection of said user indicated selection.

6. The apparatus according to claim 1, wherein said information of branch processing includes information for a plurality of executable programs organized into branches of executable programs individually selectable according to said user indicated selection.

7. The apparatus according to claim 1, wherein said information of branch processing includes information for a workflow executed upon detection of said user indicated selection.

8. The apparatus according to claim 7, wherein said workflow information includes an executable name, a workflow name, and execution parameters.

9. The apparatus according to claim 1, wherein said information of branch processing includes information for a plurality of workflows organized into branches of workflows individually selectable according to said user indicated selection.

10. The apparatus according to claim 9, wherein information for each of said plurality of workflows includes an executable name, a workflow name, and execution parameters.

11. An apparatus for performing branch processing according to a user indicated selection from displayed graphics, comprising:
means for displaying graphics generated from data included in a data file;
means for detecting a user indicated selection from said displayed graphics;
means for reading information of branch processing included in said data file; and
means for performing said branch processing according to said user indicated selection.

12. The apparatus according to claim 11, wherein said detecting means includes:
a user manipulated pointing device; and
means for receiving coordinate and control information indicative of said user indicated selection from said user manipulated pointing device.

13. The apparatus according to claim 11, wherein said data is stored in a data portion of said data file, and said information of branch processing is stored in a header portion of said data file.

14. The apparatus according to claim 11, wherein said information of branch processing includes information for an executable program executed after detection of said user indicated selection.

15. The apparatus according to claim 11, wherein said information of branch processing includes information for a plurality of executable programs organized into branches of executable programs individually selectable according to said user indicated selection.

16. The apparatus according to claim 11, wherein said information of branch processing includes information for a workflow executed after detection of said user indicated selection.

17. The apparatus according to claim 16, wherein said workflow information includes an executable name, a workflow name, and execution parameters.

18. The apparatus according to claim 11, wherein said information of branch processing includes information for a plurality of workflows organized into branches of workflows individually selectable according to said user indicated selection.

19. The apparatus according to claim 18, wherein information for each of said plurality of workflows includes an executable name, a workflow name, and execution parameters.

20. A computer readable medium stores a data file comprising:
a data portion having graphics data displayable on a computer display screen; and
a header portion having branch processing information including identification of a process option to be executed after detection of a user indicated selection from displayed graphics generated from said graphics data.

21. The computer readable medium according to claim 20, wherein said branch processing information includes information for a plurality of process options organized into branches of process options selectable according to said user indicated selection.

22. The computer readable medium according to claim 21, wherein at least one of said plurality of process options is an executable program, and said information of branch processing includes an executable name and execution parameters for that at least one executable program.

23. The computer readable medium according to claim 21, wherein at least one of said plurality of process options is a workflow, and said information of branch processing includes an executable name, a workflow name, and execution parameters for that at least one workflow.

24. A computer implemented method for performing branch processing according to a user indicated selection from displayed graphics, comprising:
displaying graphics generated from data included in a data file;
detecting a user indicated selection from said displayed graphics;
reading information of branch processing included in said data file; and
performing said branch processing according to said user indicated selection.

25. The method according to claim 24, wherein said detecting a user indicated selection from displayed graphics, comprises receiving coordinate and control information indicative of said user indicated selection from a user manipulated pointing device.

26. The method according to claim 25, wherein said coordinate information defines a point location on a computer display screen displaying said displayed graphics.

27. The method according to claim 25, wherein said coordinate information defines an area on a computer display screen displaying said displayed graphics.

28. The method according to claim 25, wherein said coordinate information indicates one of a plurality of images displayed on a computer display screen.

29. The method according to claim 24, wherein said data is stored in a data portion of said data file, and said information of branch processing is stored in a header portion of said data file.

30. The method according to claim 24, wherein said information of branch processing includes information for an executable program executed after detection of said user indicated selection.

31. The method according to claim 30, wherein said executable program information includes an executable name and execution parameters for said executable program.

32. The method according to claim 24, wherein said information of branch processing includes information for a plurality of executable programs organized into branches of executable programs individually selectable according to said user indicated selection.

33. The method according to claim 24, wherein said information of branch processing includes information for a workflow executed after detection of said user indicated selection.

34. The method according to claim 23, wherein said workflow information includes an executable name, a workflow name, and execution parameters.

35. The method according to claim 24, wherein said information of branch processing includes information for a plurality of workflows organized into branches of workflows individually selectable according to said user indicated selection.

36. The apparatus according to claim 35, wherein information for each of said plurality of workflows includes an executable name, a workflow name, and execution parameters.

37. The method according to claim 24, wherein said reading information of branch processing provided with said input data, comprises reading said information from said header.

38. The method according to claim 24, wherein said displayed graphics is in the form of a graph appearing on a computer display screen.

39. The method according to claim 24, wherein said displayed graphics is in the form of a chart appearing on a computer display screen.

40. The method according to claim 24, wherein said displayed graphics is in the form of a set of images appearing on a computer display screen.

41. The method according to claim 24, wherein said performing said branch processing according to said user indicated selection, comprises:
selecting a process branch according to control information included in said user indicated selection; and
performing a process option in said process branch.

42. The method according to claim 41, wherein said selecting a process branch according to control information included in said user indicated selection, comprises:
selecting a first process branch if said control information resulted from a user activating a first control on a pointing device; and
selecting a second process branch if said control information resulted from said user activating a second control on said pointing device.

43. The method according to claim 41, wherein said selected process includes one process option, and said performing a process option in said process branch, comprises executing said one process option according to coordinate information included in said user indicated selection.

44. The method according to claim 41, wherein said selected process branch includes a plurality of process options, and said performing a process option in said process branch, comprises:
displaying a menu of said plurality of process options;
detecting a user selected process option from said displayed menu; and
executing said user selected process option according to coordinate information included in said user indicated selection from said displayed graphics.
